(19) United States
(12) Patent Application Publication
(10) Pub. No.: US 2006/0285631 A1
(43) Pub. Date: Dec. 21, 2006

(54) Multiframe diagnostic user interface

(76) Inventor: Mike Trainor, Palatine, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/455,626

(22) Filed: Jun. 19, 2006

Related U.S. Application Data
(60) Provisional application No. 60/691,856, filed on Jun. 17, 2005.

(51) Int. Cl. H05G 1/60

(52) U.S. Cl. 378/4

(57) ABSTRACT

A method for providing a testing screen for a medical imaging system is provided. The method includes providing a first frame having selectable test icons, providing a second frame having icons that were selected to be tested from the first frame, and providing a third frame having test results from the tests that were selected in the second frame.

### PRIORITY CLAIM TO RELATED APPLICATION

This application claims priority from U.S. Provisional Patent Application Ser. No. 60/691,856, filed Jun. 17, 2005, the disclosure of which is incorporated by reference in its entirety herein.

### BACKGROUND

1. Field of the Invention

The present invention relates to the field of medical testing, and more specifically the present invention relates to multiframe diagnostic testing in the medical field.

2. Background of the Invention

Diagnosis and testing of a medical imaging system is typically performed by a computer (usually a laptop or other portable computerized device) to a control or diagnostic and maintenance port of the control network. The test computer is generally programmed to receive various types of information from the medical imaging system to allow an operator to monitor the functioning of the medical imaging system. The test computer may also be used to download new programming instructions to the medical imaging system via the control or diagnostic and maintenance port.

Conventionally, when testing is performed, the test being performed is shown. This is adequate when only one test is being performed. However, typically, a plurality of tests must be run. An operator needs to know all the options available to run additional tests. Currently, this feature is not available to operators. It makes it difficult to train new operators. New operators may have to depend on a written list to determine the available tests. This is inconvenient at times. In addition, if an operator is not aware of the next test, the operator may have to wait for the current test to end before determining what test is next.

Currently, there are no test systems that allow an operator to view a test that is currently being run, tests that were selected by the operator, and tests and options that are available to the operator.

Thus, there is a need for a test system that allows multiple screen views. Preferably the test system allows an operator to view tests that are currently being run, tests that were selected by the operator, and tests and options that are available to the operator.

### SUMMARY OF THE INVENTION

The above mentioned needs can be substantially accomplished by an interface that allows a large number of selectable software functions and multiple software functions to be run as a yet. The functionality of the software functions are presented in viewable form by the interface.

In at least one embodiment, the present invention takes the form of a method that provides a testing screen for a medical imaging system. The method includes providing a first frame having selectable test icons, providing a second frame having icons that were selected to be tested from the first frame, and providing a third frame having test results from the tests that were selected in the second frame.

An aspect of the present invention provides for the first frame, the second frame and the third frame being displayed simultaneously.

Another aspect of the present invention provides for the third frame being divided into multiple frames indicative of a number of tests selected in the second frame.

A further aspect of the present invention provides for scrolling the third frame to view results of more than one test selected in the second frame.

An aspect of the present invention provides for selecting which of the results of the selected tests to view by pressing a designated key on a keyboard.

Another aspect of the present invention provides for selecting which of the results of the selected tests to view by using a mouse to select an option from a toolbar.

### BRIEF DESCRIPTION OF THE DRAWINGS

FIG. 1 is a diagram illustrating a medical imaging system in accordance with an embodiment of the present invention;

FIG. 2 is a diagram of an exemplary multiple view screen for a medical imaging system in accordance with an embodiment of the present invention;

FIG. 3 is a block diagram illustrating a processing system in accordance with an embodiment of the present invention; and

FIG. 4 is a diagram of a flowchart illustrating a process for providing a multiple view test screen in accordance with an embodiment of the present invention.

In the figures, related elements are denoted by similar element numbers.

### DETAILED DESCRIPTION OF EXEMPLARY EMBODIMENTS

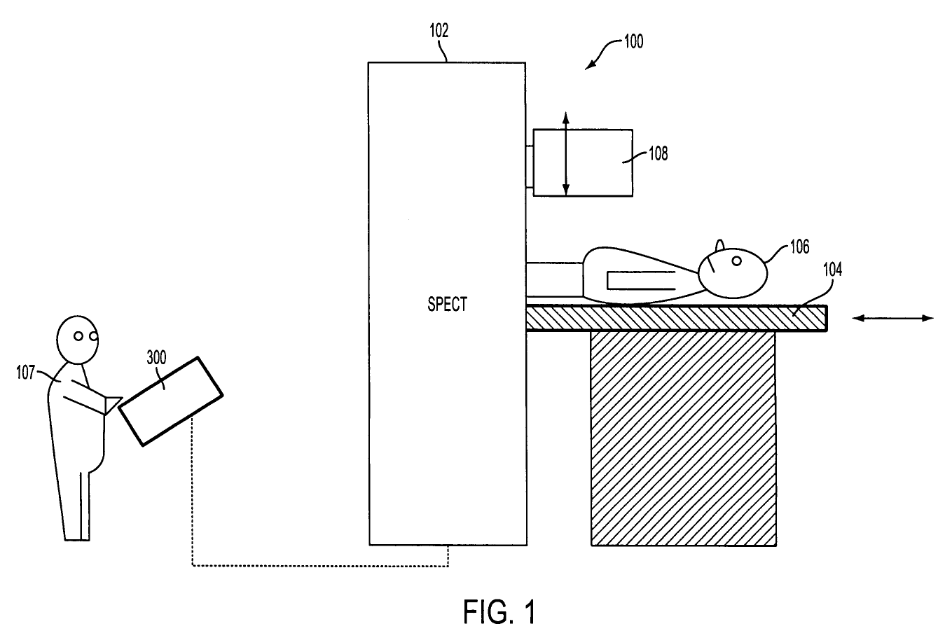

FIG. 1 is a diagram illustrating components of a nuclear medical imaging system 100 (i.e., having a gamma camera or a scintillation camera) which comprises a gantry 102 supporting one or more detectors 108 enclosed within a metal housing and movably supported proximate a patient 106 located on a patient support 104, for example, a pallet. Typically, the positions of the detectors 108 can be changed to a variety of orientations to obtain images of a patient's body from various directions. Detectors 108 can comprise collimators, scintillating elements and/or one or more photodetectors.

Usually, a data acquisition console 300 (e.g., with a user interface and/or display) is located proximate a patient during use for a technologist 112 to manipulate during data acquisition. In addition to the data acquisition console 200, images are often developed via a processing computer system which is operated at another image processing computer console including, e.g., an operator interface and a display, which may be located in another room, to develop images. By way of example, the image acquisition data may, in some instances, be transmitted to the processing computer system after acquisition using the acquisition console.

The medical imaging system 100 may comprise at least one of a Positron Emission Tomography (PET) system, a Single Photon Emission Computed Tomography (SPECT) system and a Computed Tomography (CT) system. It should be appreciated by those skilled in the art that other combinations can be used without departing from the scope of the present invention.

An operator of the medical imaging system 100 can perform diagnostics on the medical imaging system. This is usually performed during a downtime when the system is not being used such as weekends and evenings. Multiple tests are required to determine the status of different portions of the medical imaging system. It should be appreciated by those skilled in the art that in accordance with embodiments of the present invention, that the tests can be performed on an individual in accordance with standard image capturing functions. The different types of tests taken can benefit from the present invention since multiple screens are required.

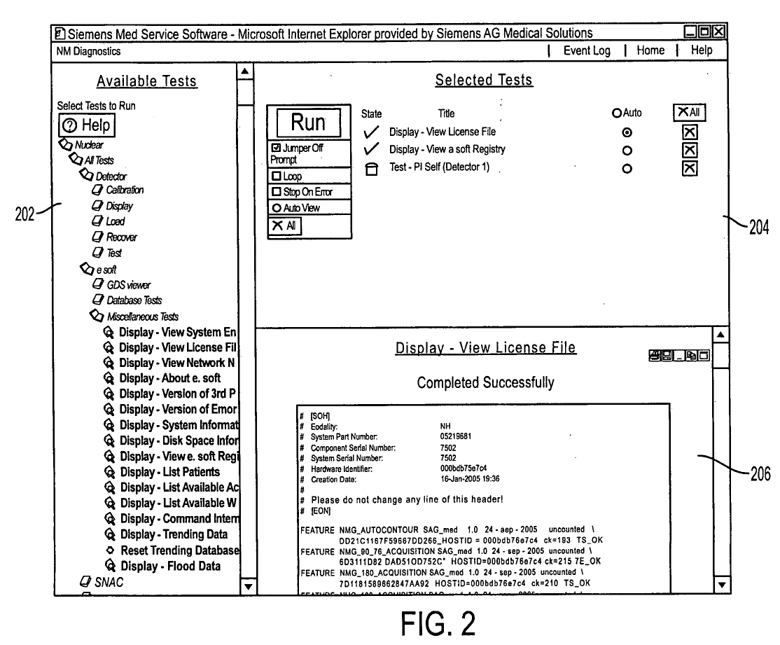

FIG. 2 is a diagram of an exemplary multiple view screen for a medical imaging system in accordance with an embodiment of the present invention. A display terminal associated with data acquisition console 300 provides image 200. Image 200 comprises a first portion comprising an available test portion 202 also known as test selection frame, a second portion comprising a selected tests portion 204 also known as a selected tests frame, and a third portion comprising a test results portion 206 also known as a results frame. It should be appreciated by those skilled in the art that the present invention is not limited to three test frames. For example, a plurality of test results portions can be shown when at least two tests are selected. In one embodiment of the present invention, the test results portion 206 can show the test results in one frame with the frame split into two. In another embodiment of the present invention, the test results portion 206 can show the test results based on operator input. For example, the operator, can select which test results to show by scrolling down the screen, or by using the mouse or a key stroke to select the test result to be shown via a menu e.g., selected tests 204.

In the exemplary illustration, available tests portion 202 comprises a number of folders comprising help screens and the tests to be run. The Nuclear folder indicates that the medical imaging system 100 is a nuclear based system. The All Tests allows an operator to see all the available tests. An operator may have to scroll down or up to see all the available tests. The Detector indicates the detectors 108. Calibration, Display, Load, Recover, and Test indicate options that can be performed related to the detectors 108.

The available tests frame 202 is arranged hierarchically. Tests are located by navigating the hierarchy and clicking on the test titles to add the titles to the list of tests to be run. All of the tests in a folder may be added by clicking on the folder name. Clicking the folder icon opens the folder. It should be appreciated by those skilled in the art that the present invention can be practiced without a hierarchical structure.

Miscellaneous Tests indicate the various tests that can be performed on the medical imaging system 100. These various tests comprise View System Errors, View License File, View Network Nodes, Version of 3^{rd} Party Software, System Information, Disk Space Information, View e-soft Registry, List Patients, List Available Accounts, List Available Workers, Command Interface, Trending Data, Reset Trending Database and Display Flood Data.

The selected tests frame 204 indicates the tests that the operator has selected. In this case, the operator has selected to view the License File, view the e-soft Registry and to run the test PI Self (Detector). The operator can easily see based the tests that are available and the tests that were selected. This embodiment of the present invention allows a novice to run tests since there is no requirement that the novice remember the location of the tests and the status of the tests.

The selected tests frame 204 comprises the list of tests that the operator has selected to run. Pressing the Run button will run all the tests. The general test result e.g. Pass/Fail/Aborted/Not Run/Waiting for Input, can be seen at a glance. The selected tests may be run in a loop. In an embodiment of the present invention, test execution can be stopped when a test error is encountered.

Test results frame 206 allows the operator to conveniently view the test results. In this case, the e-soft Registry and a portion of the License File are shown. If an operator wants to modify the test, it can be conveniently be done.

Test results frame 206 comprises the results from at least one test. Each test in the selected tests frame has a radio button used to determine which test result to view. In an embodiment of the present invention, an auto-view radio window may be selected so that the results from the currently running tests may be viewed.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

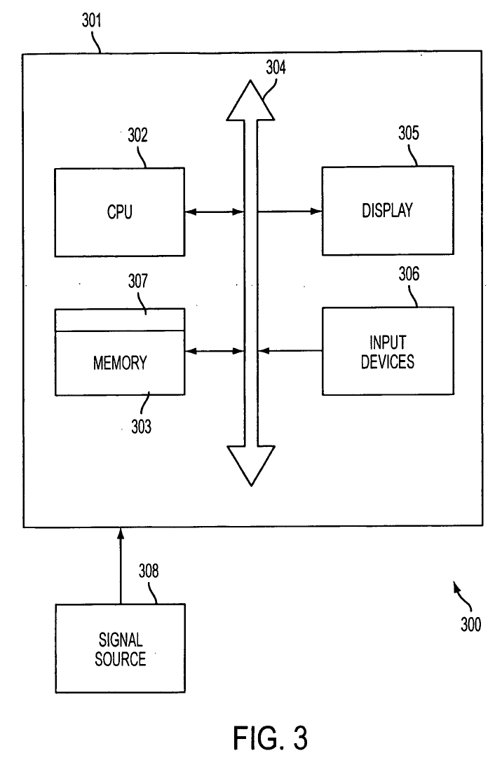

Referring now to FIG. 3, according to an embodiment of the present invention, a computer system 301 for implementing the present invention can comprise, inter alia, a central processing unit (CPU) 302, a memory 303 and an input/output (I/O) interface 304. The computer system 301 is generally coupled through the I/O interface 304 to a display 305 and various input devices 306 such as a mouse and a keyboard. The support circuits can include circuits such as cache, power supplies, clock circuits, and a communication bus. The memory 303 can include random access memory (RAM), read only memory (ROM), disk drive, tape drive, etc., or a combinations thereof. The present invention can be implemented as a routine 307 that is stored in memory 303 and executed by the CPU 302 to process the signal from the signal source 308. As such, the computer system 301 is a general purpose computer system that becomes a specific purpose computer system when executing the routine 307 of the present invention.

The computer system 301 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It should be appreciated by those skilled in the art that the process for providing a multiple view test screen can reside in the medical imaging system or in a computer attached directly or remotely to the medical imaging system.

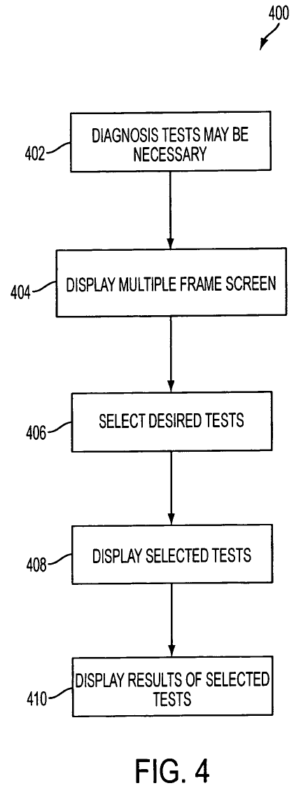

FIG. 4 is a diagram of a flowchart illustrating a process for providing a multiple view test screen in accordance with an embodiment of the present invention. The process 400 begins at step 402 where an operator decides to run various tests on a medical imaging system 100. It should be appreciated by those skilled in the art that the testing being performed may also be done on a patient and still fall within the scope of the present invention.

At step 404, a multiple frame test screen is displayed. The multiple frame test screen comprises an available tests frame, a selected test frames and a results test frame. The process 400 proceeds to step 406.

At step 406, the operator selects desired tests from the available tests frame. At step 408, the selected tests are displayed in the selected tests frame. The process 400 proceeds to step 410 where the results of the tests are displayed in the results tests frame.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for providing a testing screen for a medical imaging system comprising:
providing a first frame having selectable test icons;
providing a second frame having icons that were selected to be tested from the first frame; and
providing a third frame having test results from the tests that were selected in the second frame.

2. The method as recited in claim 1, wherein the first frame, the second frame and the third frame are displayed simultaneously.

3. The method as recited in claim 1, wherein the third frame is divided into multiple frames indicative of a number of tests selected in the second frame.

4. The method as recited in claim 1, further comprising:
scrolling the third frame to view results of more than one test selected in the second frame.

5. The method as recited in claim 1, further comprising:
selecting which of the results of the selected tests to view by pressing a designated key on a keyboard.

6. The method as recited in claim 1, further comprising:
selecting which of the results of the selected tests to view by using a mouse to select an option from a toolbar.

7. The method as recited in claim 1, wherein the tests comprise diagnostics on the medical imaging system.

8. The method as recited in claim 1, wherein the tests in the first frame comprises at least one of calibration, display, load and recover.

9. The method as recited in claim 1, wherein the tests in the first frame comprises miscellaneous tests.

10. The method as recited in claim 1, wherein the medical imaging system comprises a SPECT.

11. The method as recited in claim 1, wherein the medical imaging system comprises a CT.

12. The method as recited in claim 1, wherein the medical imaging system comprises a CT.

13. The method as recited in claim 1, wherein the test icons in the first frame comprises at least one of folders.

15. The method as recited in claim 1, wherein the test icons in the first frame comprises the names of available tests.

16. A computer readable medium having instructions for providing a testing screen for a medical imaging system comprising:
a first set of instructions for providing a first frame having selectable test icons;
a second set of instructions for providing a second frame having icons that were selected to be tested from the first frame; and
a third set of instructions for providing a third frame having test results from the tests that were selected in the second frame.
